(19) United States
(12) Patent Application Publication
(10) Pub. No.: US 2011/0032897 A1
(43) Pub. Date: Feb. 10, 2011

(54) METHOD OF ALLOCATING ACKNOWLEDGEMENT CHANNEL

(75) Inventors: Bin Chul Ihm, Anyang-si (KR); Jeong Ki Kim, Anyang-si (KR); Ki Seon Ryu, Anyang-si (KR)

Correspondence Address: BIRCH STEWART KOLASCH & BIRCH, PO BOX 747, FALLS CHURCH, VA, 22040-0747, US

(73) Assignee: LG ELECTRONICS INC., Seoul (KR)

(21) Appl. No.: 12/937,517

(22) PCT Filed: Apr. 14, 2009
(86) PCT No.: PCT/KR2009/001911

§ 371 Date: Oct. 19, 2010

Related U.S. Application Data
(60) Provisional application No. 61/044,511, filed on Apr. 14, 2008.

(30) Foreign Application Priority Data
Sep. 26, 2008 (KR) 10-2008-0094815

(51) Int. Cl. H04W 72/00

(52) U.S. Cl. 370/329

(57) ABSTRACT

Various methods for efficiently transmitting data and various methods for allocating an ACK channel in a wireless access system are disclosed. In addition, various frame structures and MAC header structures for use in allocating an ACK channel are disclosed. A method for allocating an ACK channel includes receiving first data including ACK channel position information, transmitting an ACK signal on an ACK channel indicated by the ACK channel position information, and starting an ACK channel timer.

This application claims the benefit of Provisional Patent Application No. 61/044,511, filed on Apr. 14, 2008, and the benefit of Korean Patent Application No. 10-2008-0094815, filed on Sep. 26, 2008, which are hereby incorporated by references as if fully set forth herein.

### BACKGROUND OF THE INVENTION

1. Field of the Invention

The present invention relates to a method for efficiently transmitting data and a method for allocating an ACKnowledgement (ACK) channel in a wireless access system, and more particularly, to a frame structure and a Medium Access Control (MAC) header structure, for use in allocating an ACK channel.

2. Discussion of the Related Art

A frame structure used in a broadband wireless access system will be described briefly.

FIG. 1 illustrates a typical frame structure.

Referring to FIG. 1, the horizontal axis represents Orthogonal Frequency Division Multiple Access (OFDMA) symbols as time units and the vertical axis represents the logical numbers of subcarriers as frequency units, in a frame. A frame is divided into data sequence channels each having a predetermined duration according to the physical characteristics of the data sequence channels in FIG. 1. Specifically, a frame is divided into a DownLink (DL) subframe and an UpLink (UL) subframe. A Transmit/receive Transition Gap (TTG) is interposed between a DL subframe and a UL subframe and a Receive/transmit Transition Gap (RTG) is interposed between frames.

A DL subframe may carry a preamble, a Frame Control Header (FCH), a DL-MAP, a UL-MAP, and one or more DL data bursts. A UL subframe may carry one or more UL data bursts and a ranging subchannel.

The preamble is a predetermined data sequence residing in the first symbol of each frame, for use in acquisition of synchronization with a Base Station (BS) and channel estimation at a Mobile Station (MS). The FCH provides information about channel allocation and channel coding of the DL-MAP. The DL-MAP and the UL-MAP are MAC messages carrying channel resource assignments to MSs. The DL data bursts and the UL data bursts are data units that the BS transmits to MSs or MSs transmit to the BS.

A Downlink Channel Descriptor (DCD) that can be transmitted in the frame structure illustrated in FIG. 1 is a MAC message describing the physical characteristics of a downlink channel and an Uplink Channel Descriptor (UCD) is a MAC message describing the physical characteristics of an uplink channel.

On a downlink, an MS may detect a preamble transmitted from a BS and then decode a DL-MAP using information acquired from an FCH. The BS may transmit scheduling information to MSs in every frame (e.g. every 5 ms) in a DL-MAP or UL-MAP message to allocate downlink or uplink resources to the MSs.

Because the DL-MAP and UL-MAP messages described above with reference to FIG. 1 are transmitted at a Modulation Coding Scheme (MCS) level that allows all MSs to receive the DL-MAP and UL-MAP messages, unnecessary MAP message overhead may be caused. For instance, MSs near to a BS use a high MCS level (e.g. QPSK 1/2) to encode and decode a message because they are in good channel state. However, the BS may encode a MAP message at a low MCS level (e.g. QPKS 1/12) and transmit the encoded MAP message, for MSs at a cell edge, ignoring the situation of the MSs in the good channel state. Consequently, each MS should receive a message encoded at the same MCS level irrespective of the channel state of the MS, thereby causing unnecessary MAP message overhead.

A description will be given below of a typical data transmission method between a transmitter and a receiver.

When the transmitter fails in transmitting data to the receiver, the receiver requests retransmission of the failed data to the transmitter. In general, Automatic Repeat reQuest (ARQ) is adopted as a data retransmission scheme.

According to ARQ, after receiving data, the receiver notifies the transmitter whether the data reception is successful or failed by transmitting an ACK or Negative ACK (NACK) signal. Upon receipt of the NACK signal, the transmitter retransmits the data to the receiver. ARQ schemes are classified into Stop-And-Wait (SAW) ARQ, Go-Back-N (GBN) ARQ and Selective-Repeat (SR) ARQ.

In SAW ARQ, after transmitting data, the transmitter awaits reception of an ACK or NACK signal. Upon receipt of an ACK signal for the transmitted data, the transmitter transmits the next data. On the other hand, upon receipt of a NACK signal for the transmitted data, the transmitter retransmits the previous data. That is, only one frame is transmitted at one time. The transmitter does not transmit the next frame until it confirms that the current frame has been successfully transmitted.

GBN ARQ is a data retransmission scheme in which the transmitter continuously transmits data irrespective of reception of a response message. If the receiver fails to receive data of a specific frame, the receiver does not transmit an ACK signal for the specific frame to the transmitter. Because the transmitter does not receive an ACK signal for the specific frame, the transmitter retransmits data, starting from the specific frame.

In SR ARQ, the transmitter continuously transmits data and retransmits only data for which a NACK signal is received. When the receiver fails to receive data of a specific frame, the receiver transmits a NACK signal to the transmitter. Upon receipt of the NACK signal from the receiver, the transmitter retransmits the data of the failed frame to the receiver, thus completing data transmission. SR ARQ requires assignment of a sequence number to each frame, which makes the implementation of SR ARQ relatively complex.

In the case where data is transmitted in packets, higher data rates are required along with the development of communication technology. To prevent errors in a high-rate transmission environment, suitable coding rates or modulation schemes have been applied to communication systems. In addition, an ARQ scheme suitable for the high-rate transmission environment was required. That is, Hybrid ARQ (HARQ) was proposed.

Compared to ARQ in which erroneous information is discarded, a receiver buffers erroneous information, combines the buffered information with retransmission information, and applies Forward Error Correction (FEC) to the combined information in HARQ. That is, HARQ is a combination of ARQ and FEC. Four HARQ schemes are available.

In HARQ Type 1, the receiver applies FEC by always checking the error detection code of data. If a packet has errors, the receiver requests retransmission of the packet. The receiver discards the erroneous packet and the transmitter transmits a retransmission packet with the same FEC as that of the discarded packet.

In HARQ Type 2 called Incremental Redundancy (IR) ARQ, the receiver buffers an initial transmission packet in a buffer and combines retransmitted redundancy bits with the initial transmission packet. The transmitter transmits only parity bits except data bits at a retransmission. The parity bits are different at different retransmissions.

HARQ Type 3 is a special case of HARQ Type 2. Each packet is self-decodable. At a retransmission, the transmitter configures a packet including both an erroneous part and data. This scheme enables accurate decoding, relative to HARQ Type 2, but it is inefficient in coding gain.

HARQ Type 4 is implemented by adding a function of buffering initial transmission data and combining the buffered initial transmission data with retransmission data to HARQ Type 1. HARQ Type 4 is called metric combining or chase combining. HARQ Type 4 is advantageous in terms of Signal to Interference Noise Ratio (SINR) and always uses the same parity bits for retransmission data.

When errors occur to data transmission or data is lost, the above data retransmission schemes enable recovery of the original data.

### SUMMARY OF THE INVENTION

In general, an MS may transmit an ACK or NACK signal for downlink data to a BS, on an uplink HARQ ACK channel allocated to the MS. The BS may transmit an ACK or NACK signal for uplink data to the MS, on a downlink HARQ ACK channel allocated to the MS. Upon receipt of a NACK signal from a receiver, a transmitter retransmits data to the receiver using an appropriate (or preset) HARQ scheme.

The BS can notify the MS of the position of an allocated uplink ACK channel for ACK or NACK transmission, largely in two methods.

One is an explicit method. The BS indicates the position of an uplink HARQ ACK channel to the MS by explicit signaling. When allocating HARQ resources to the MS, the BS may transmit resource allocation information in an explicit signal to the MS.

The other method is an implicit one. The MS can determine the position of an uplink HARQ ACK channel using system information, without explicit signaling. For example, the MS may acquire information about the position of an uplink HARQ ACK channel based on the number of MAPs, a Resource Block (RB) or a Common Control Element (CCE).

In an Institute of Electrical and Electronics Engineers (IEEE) 802.16 system, a UL-MAP (or a compressed MAP or sub-dl-ul-map) containing uplink resource allocation information is encoded to one MAC message for each MS group. Therefore, upon receipt of the UL-MAP, an MS determines the position of resources allocated for transmission of an uplink HARQ ACK/NACK signal for downlink data transmitted to the MS by detecting MAP Information Elements (IEs) in the UL-MAP.

Scheduling information is separately encoded on an MS basis in a 3^{rd} Generation Partnership Project (3GPP) Long Term Evolution (LTE) system. Hence, an MS does not know how many pieces of scheduling information exist before scheduling information for the MS. Accordingly, it is preferable to allocate uplink HARQ ACK channels in units of a smallest number of CCEs.

However, notifying the position of an HARQ ACK channel using a scheduling message (e.g. a MAP message) causes great downlink resource consumption because every resource allocation message should always include an HARQ ACK channel index.

Especially, a scheduling message is transmitted at a lower MCS level than general data in order to reduce errors, because the scheduling message is a control message. As a result, to deliver information of the same size, a scheduling message occupies more resources than general data.

If uplink HARQ ACK channels are allocated in units of a smallest number of CCEs or RBs, as many uplink HARQ ACK channels as the smallest number of CCEs or a total number of RBs are allocated. Therefore, more uplink ACK channels than actual downlink resource assignments may be allocated, causing unnecessary uplink resource consumption.

Accordingly, the present invention is intended to substantially obviate one or more problems due to limitations and disadvantages of the related art. An object of the present invention is to provide a method for efficiently transmitting data.

Another object of the present invention is to provide a method for allocating an ACK channel.

Another object of the present invention is to provide a method for allocating an ACK channel using a MAC header.

Another object of the present invention is to provide a new frame structure for use in allocating an ACK channel.

Another object of the present invention is to provide a new MAC header for use in allocating an ACK channel.

A further object of the present invention is to provide a method for notifying an HARQ ACK channel index using an in-band signaling scheme.

To achieve these objects and other advantages and in accordance with the purpose of the invention, as embodied and broadly described herein, the present invention provides a method for allocating an ACK channel and a MAC header structure for use in allocating an ACK channel.

In an aspect of the present invention, a method for allocating an ACK includes receiving first data including ACK channel position information, transmitting an ACK signal on an ACK channel indicated by the ACK channel position information, and starting an ACK channel timer. When the ACK channel is initially allocated or already set ACK channel position information is changed, the ACK channel position information may be included in the first data.

The ACK channel position information may be included in a header of the first data. The header may be one of a Generic Medium Access Control (MAC) Header (GMH), a subheader, and an extended subheader. The GMH may include a first indicator indicating whether the ACK channel position information is included. The first indicator may be allocated to a reserved bit of the GMH or a type field of the MAC header.

The MAC header may include a GMH and a subheader and the first indicator may indicate whether the ACK channel position information is included in the subheader.

The subheader may include a type field and a body field. The type field may indicate whether the body field includes the ACK channel position information.

The MAC header may include a GME and an extended subheader and the first indicator may indicate whether the ACK channel position information is included in the extended subheader.

The method may further include receiving second data that does not include the ACK channel position information. When the ACK channel position information is needed, the ACK channel position information may be selectively included in the first data.

The method may further include deleting the ACK channel position information, upon expiration of the ACK channel timer.

In another aspect of the present invention, a method for allocating an ACK channel includes transmitting first data including ACK channel position information, receiving an ACK signal on an ACK channel indicated by the ACK channel position information, and starting an ACK channel timer, upon receipt of the ACK signal. When the ACK channel is initially allocated or already set ACK channel position information is changed, the ACK channel position information may be selectively included in the first data.

The method may further include transmitting a second message that does not include the ACK channel position information.

The ACK channel position information may be included in a header of the first data and the header may be one of a GMH, a subheader, and an extended subheader. The GMH may include a first indicator indicating whether the ACK channel position information is allocated.

The MAC header may include a GMH and a subheader and the first indicator may indicate whether the ACK channel position information is allocated in the subheader.

The subheader may include a type field and a body field and the type field may indicate whether the body field includes the ACK channel position information.

The MAC header may include a GMH and an extended subheader, and the GMH may include an indicator indicating whether the ACK channel position information is allocated in the extended subheader.

The method may further include deleting the ACK channel position information, upon expiration of the ACK channel timer.

### BRIEF DESCRIPTION OF THE DRAWINGS

In the drawings:

FIG. 1 illustrates a typical frame structure.

FIG. 2 illustrates one of methods for transmitting information about the position of an ACK channel according to an embodiment of the present invention.

FIG. 3 is a flowchart illustrating one of methods for transmitting an HARQ ACK channel index according to an embodiment of the present invention.

FIG. 4 is a flowchart illustrating another of the methods for transmitting an HARQ ACK channel index according to the embodiment of the present invention.

FIG. 5 illustrates an exemplary MAC PDU structure that can be used in embodiments of the present invention.

FIG. 6 illustrates an exemplary MAC header that can be used in embodiments of the present invention.

FIG. 7 illustrates another exemplary MAC header that can be used in embodiments of the present invention.

FIG. 8 illustrates an exemplary method for allocating an ACK channel according to an embodiment of the present invention.

FIG. 9 illustrates another exemplary method for allocating an ACK channel according to the embodiment of the present invention.

FIG. 10 illustrates another exemplary method for allocating an ACK channel according to the embodiment of the present invention.

FIG. 11 illustrates a further exemplary method for allocating an ACK channel according to the embodiment of the present invention.

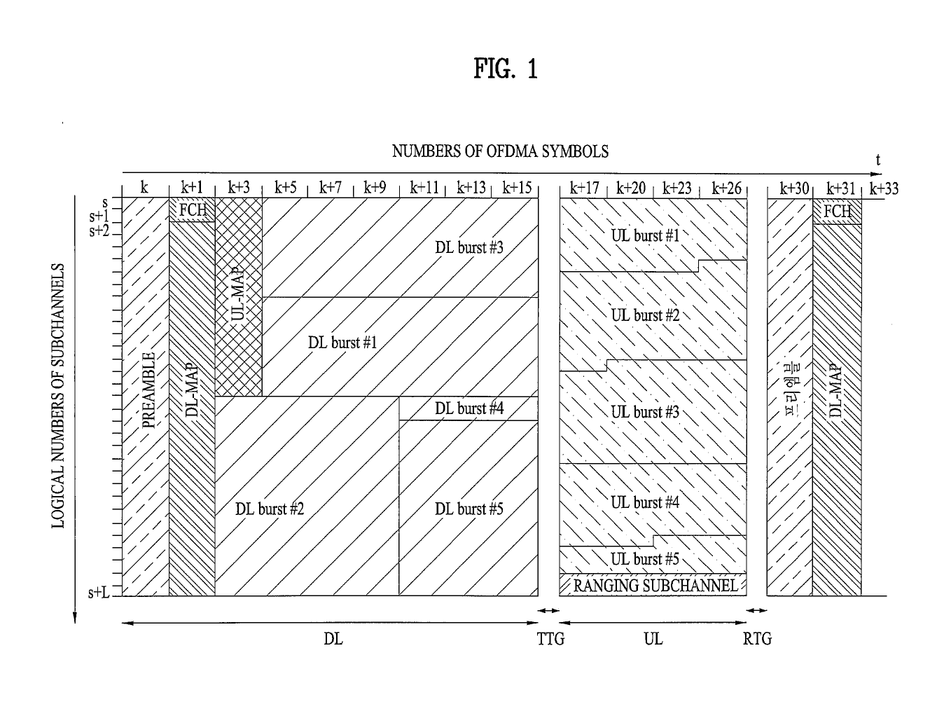

### DETAILED DESCRIPTION OF THE INVENTION

The present invention relates to a method for efficiently transmitting data and a method for allocating an ACKnowledgement (ACK) channel in a wireless access system.

The embodiments of the present invention described hereinbelow are combinations of elements and features of the present invention. The elements or features may be considered selective unless otherwise mentioned. Each element or feature may be practiced without being combined with other elements or features. Further, an embodiment of the present invention may be constructed by combining parts of the elements and/or features. Operation orders described in the embodiments of the present invention may be rearranged. Some constructions of any one embodiment may be included in another embodiment or may be replaced with corresponding constructions of another embodiment.

In the embodiments of the present invention, a description is made of a data transmission and reception relationship between a Base Station (BS) and a Mobile Station (MS). Herein, the term ‘BS’ refers to a terminal node of a network, which communicates directly with the MS. In some cases, a specific operation described as performed by the BS may be performed by an upper node of the BS.

Namely, it is apparent that, in a network comprised of a plurality of network nodes including a BS, various operations performed for communication with an MS may be performed by the BS, or network nodes other than the BS. The term ‘BS’ may be replaced with the term ‘fixed station’, ‘Node B’, ‘eNode B (eNB)’, ‘access point’, etc. The term used herein ‘terminal’ may be replaced with the term ‘User Equipment (UE)’, ‘MS’, ‘Mobile Subscriber Station (MSS)’, etc.

Embodiments of the present invention may be achieved by various means, for example, hardware, firmware, software, or a combination thereof.

In a hardware configuration, methods according to embodiments of the present invention may be achieved by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, the methods according to the embodiments of the present invention may be implemented in the form of a module, a procedure, a function, etc. performing functions or operations as set forth herein. Software code may be stored in a memory unit and executed by a processor. The memory unit is located at the interior or exterior of the processor and may transmit and receive data to and from the processor via various known means.

The embodiments of the present invention may be supported by standard documents disclosed for at least one of wireless access systems including an Institute of Electrical and Electronics Engineers (IEEE) 802 system, a 3^{rd} Generation Project Partnership (3GPP) system, a 3GPP Long Term Evolution (LTE) system, and a 3GPP2 system. In particular, the steps or parts, which are not described to clearly reveal the technical idea of the present invention, in the embodiments of the present invention may be supported by the above documents. All terms used in the embodiments of the present invention may be explained by the standard documents. Especially the embodiments of the present invention may be supported by at least one of P802.16e-2005 or P802.16Rev2 documents which are the standards of IEEE 802.16.

The term used in embodiments of the present invention, ‘ACK channel position information’ may be expressed as an ACK CHannel (ACKCH) index or an ACK region index.

Specific terms used for the embodiments of the present invention are provided to help the understanding of the present invention. These specific terms may be replaced with other terms within the scope and spirit of the present invention.

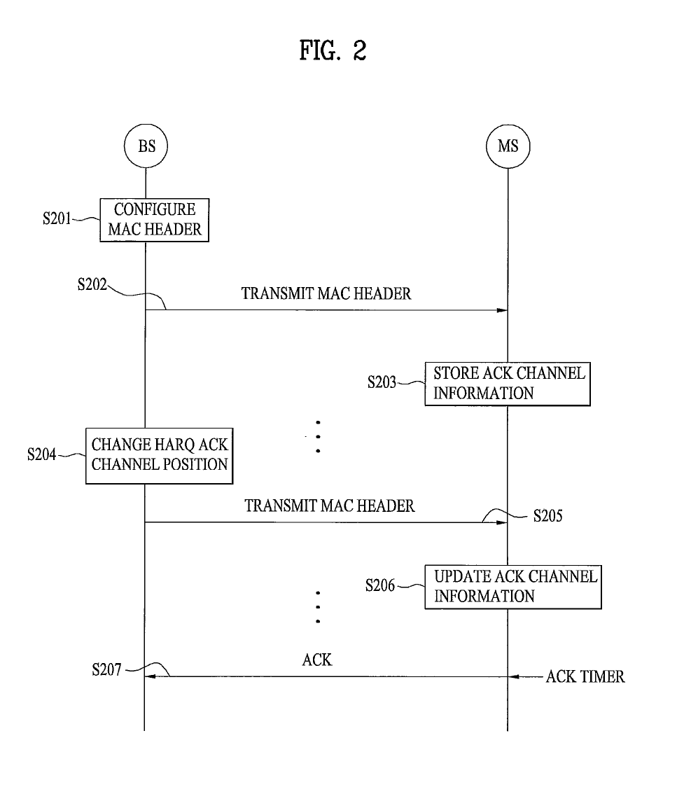

FIG. 2 illustrates one of methods for transmitting information about the position of an ACK channel according to an embodiment of the present invention.

Referring to FIG. 2, a BS may configure a Medium Access Control (MAC) header including ACK channel position information (e.g. an HARQ ACKCH Index) for an MS (S201).

The BS may transmit the MAC header to the MS (S202).

The MS may acquire the ACK channel position information from the MAC header and store the ACK channel position information for a predetermined time (S203).

The MS may transmit to the BS an ACK signal for downlink data transmitted by the BS. Specifically, the MS may transmit an ACK signal to the BS on an ACK channel indicated by the ACK channel position information stored in step S202.

The MS and the BS may set a timer for ACK channel information. For example, the MS may transmit the ACK signal to the BS using the ACK channel information. Preferably, the MS starts the timer after transmitting the ACK signal and the BS starts the timer after receiving the ACK signal.

During communication between the MS and the BS, the position of the ACK channel allocated to the MS may be changed (S204).

In this case, the BS may transmit a MAC header including information about the position of the changed ACK channel to the MS (S205).

If the stored ACK channel position information is different from the latest received ACK channel position information, the MS may update the stored ACK channel position information to the new ACK channel position information and store the updated ACK channel position information (S206).

The MS may transmit to the BS an ACK signal for downlink data transmitted by the BS, on an ACK channel indicated by the new ACK channel position information. After transmitting the ACK signal, the MS may set the ACK timer (S207).

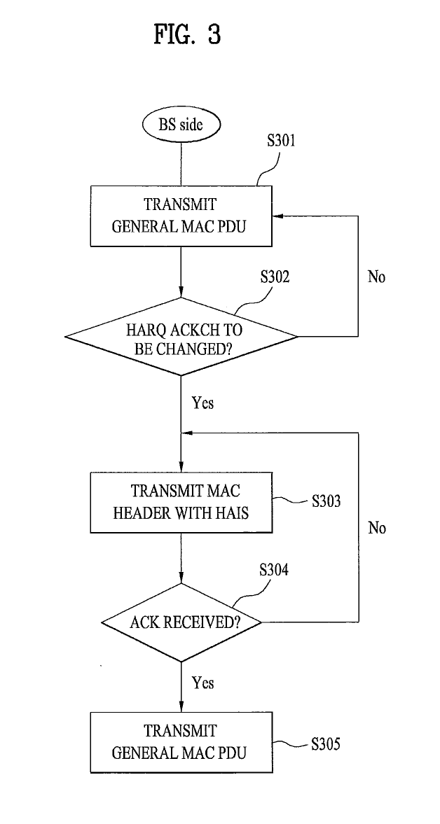

FIG. 3 is a flowchart illustrating one of methods for transmitting an HARQ ACK channel index in a BS according to an embodiment of the present invention.

Referring to FIG. 3, the BS may transmit a general MAC Protocol Data Unit (PDU) without HARQ ACK channel information to an MS (S301).

An HARQ ACK channel allocated to the MS may need to be changed according to a communication environment (S302).

If the HARQ ACK channel is changed, the BS may configure a MAC header including an HARQ ACKCH Index Subheader (HAIS) and transmit the MAC header to the MS (S303).

On the other hand, if the HARQ ACK channel is not changed in step S302, the BS may continue to transmit a general MAC PDU to the MS.

In the case where the BS allocates an ACK channel to the MS using a MAC PDU, the MS may transmit an ACK signal for the MAC PDU on the ACK channel. Upon receipt of the ACK signal, the BS transmits a general MAC PDU to the MS when the ACK channel allocated to the MS does not need to be changed (S303). If the BS has not received the ACK signal, the BS may transmit a MAC header including a HAIS to the MS, determining that an ACK channel has not been successfully allocated to the MS (S305).

Even though the BS receives an ACK signal from the MS, the BS may transmit a MAC header with a HASI to the MS if there is a need to change the ACK channel, in step S305.

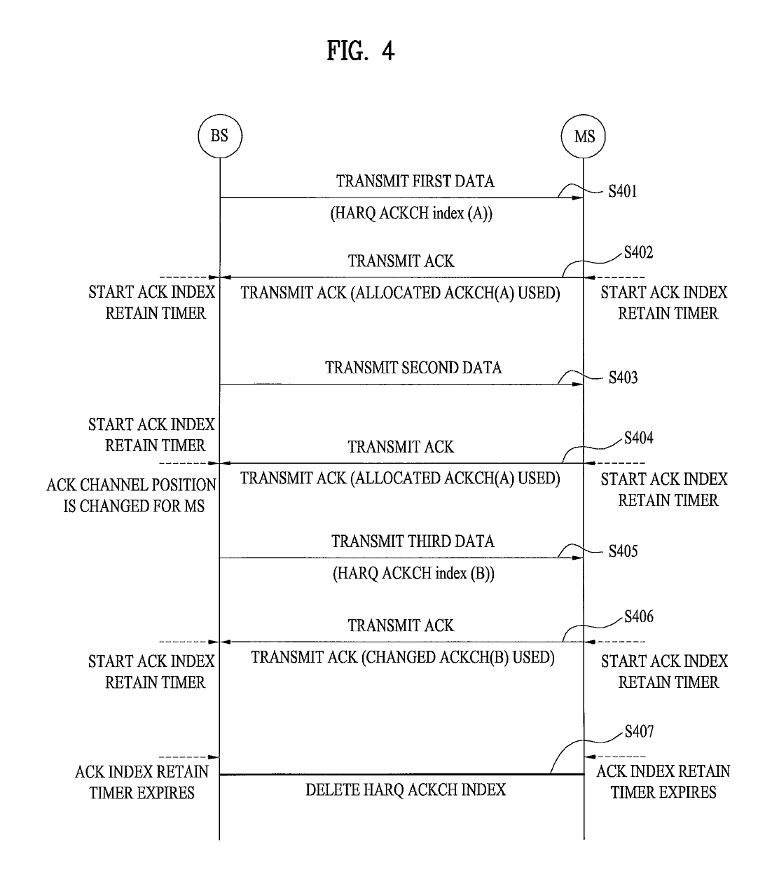

FIG. 4 is a flowchart illustrating another of the methods for transmitting an HARQ ACK channel index according to the embodiment of the present invention.

Referring to FIG. 4, the BS may transmit first downlink data to the MS. If an HARQ ACKCH index has not been allocated for the first downlink data or the first data is initial transmission data, the BS may transmit an HARQ ACKCH index(A) in a MAC header to the MS (S401).

Upon receipt of the first data, the MS may store the HARQ ACKCH Index(A) and transmit an ACK signal on an ACK channel, ACKCH(A) indicated by the HARQ ACKCH index (S402).

After transmitting the ACK signal to the BS in step S402, the MS may start an ACK index retain timer. In addition, the BS may start an ACK index retain timer after receiving the ACK signal from the MS. The ACK index retain timer indicates the valid duration of an ACK channel indicated by an HARQ ACKCH index. The ACK index retain timer may be set in each of the MS and the BS.

The BS may transmit second data to the MS. If the ACKCH(A) allocated to the MS has not been changed by the BS Or according to a communication environment, the BS may transmit the second data without an HARQ ACKCH index to the MS (S403).

When an HARQ ACKCH index is not included in the MAC header of the received second data, the MS may transmit an ACK signal to the BS on the ACKCH(A) indicated by the stored HARQ ACK channel index(A) (S404).

The MS may reset the ACK index retain timer after transmitting the ACK signal in step S404. In addition, the BS may reset the ACK index retain timer after receiving the ACK signal.

When it is necessary to change the ACK channel, ACKCH(A) allocated to the MS, the BS may transmit third data including a changed HARQ ACK channel index (B) to the MS (S405).

If the HARQ ACKCH Index(B) included in the MAC header of the received third data is different from the stored HARQ ACK channel index the MS may update the stored HARQ ACK channel index to the new HARQ ACKCH Index(B) and transmit an ACK signal to the BS on the ACK channel, ACKCH(B)(S406).

The MS may reset the ACK index retain timer after transmitting the ACK signal to the BS and the BS may reset the ACK index retain timer after receiving the ACK signal from the MS.

If there is no data to be transmitted between the MS and the BS for a predetermined time, the ACK index retain timer may expire. Upon expiration of the ACK index retain timer, the MS and the BS may delete the stored HARQ ACK channel index, HARQ ACKCH Index(B) (S407).

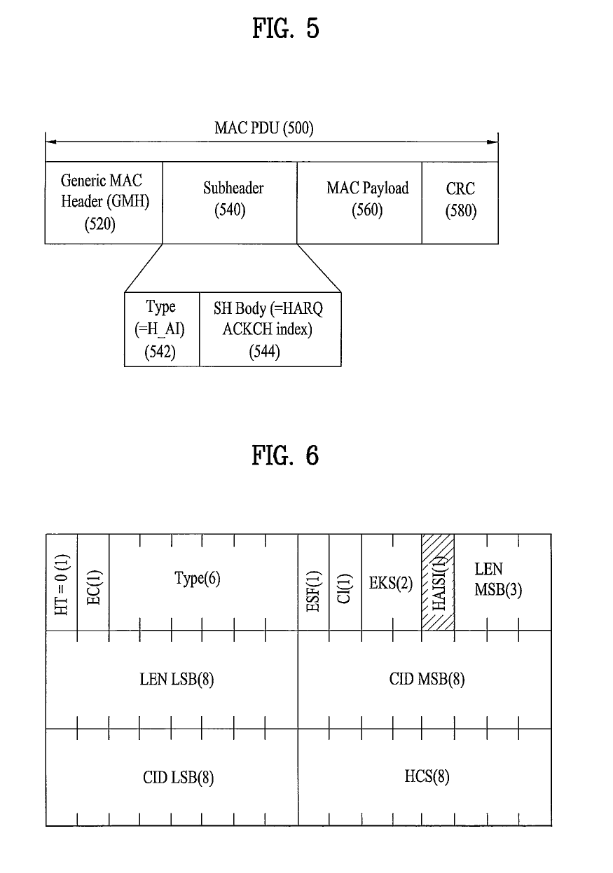

FIG. 5 illustrates an exemplary MAC PDU structure that can be used in embodiments of the present invention.

Referring to FIG. 5, a MAC PDU 500 is a data unit. The MAC PDU 500 may include a MAC header, MAC payload 560, and a Cyclic Redundancy Code (CRC) 580. The MAC header may include a Generic MAC Header (GMH) 520 and a subheader 540.

In FIG. 5, the subheader 540 may include a subheader region containing one type of information, or a Type field 542 and a Body field 544. In the latter case, the Type field 542 may include an indicator H_AI indicating whether an HARQ ACK channel index is included in the subheader and the Body field 544 may include an actual HARQ ACK channel index.

This subheader configuration is applicable to a new system such as IEEE 802.16m. The subheader is also identical in configuration to an Extended SubHeader (ESH) used in IEEE 802.16e. That is, if an Extended Subheader Field (ESF) indicating an ESH is set to ‘1’ in an IEEE 802.16e GMH, the ESH may follow the GMH and the type of the ESH may be identified by a Type field of the ESH. A header type may be identified by an HARQ ACK index (H_AI) in the present invention.

FIG. 6 illustrates an exemplary MAC header that can be used in embodiments of the present invention.

The MAC header may include a GMH and one or more subheaders. A subheader may be inserted after the GMH. Each field included in the GMH will be described below in detail.

A Header Type (HT) field indicates the type of the MAC header. The HT field indicates whether the header of the MAC PDU is a GMH including payload after the header, or a signaling header for control, such as bandwidth request.

An Encoding Control (EC) field represents encoding control, indicating whether the payload was encrypted. A Type field indicates whether a subheader follows the header and the type of the subheader. An ESF indicates whether an ESH follows the GMH.

A CI field indicates whether a CRC is attached to the payload. An Encryption Key Sequence (EKS) field indicates an encryption key sequence number used for encryption, when the payload is encrypted. A LENgth (LEN) field specifies the length of the MAC PDU. A Connection Identifier (CID) field indicates the connection ID of the MAC PDU. A connection is used as an ID in a MAC layer, for delivering data and messages between a BS and an MS. A CID functions to identify a specific MS or a specific service between a BS and an MS. A Header Check Sequence (HCS) field is used to detect errors in the header. The numerals within the brackets following the names of the fields indicate the variable number of bits of each of the fields.

Referring to FIG. 6, a reserved bit following the EKS field may be allocated as an HARQ ACK channel Index Subheader Indicator (HAISI). That is, a HAISI field may be allocated between the EKS field and a LEN MSB field.

The HAISI field is 1 bit long, indicating whether the following subheader includes an HARQ ACK channel index. For example, if the HAISI is 1 bit and set to 1, this implies that a subheader including an HARQ ACK channel index follows the GMH.

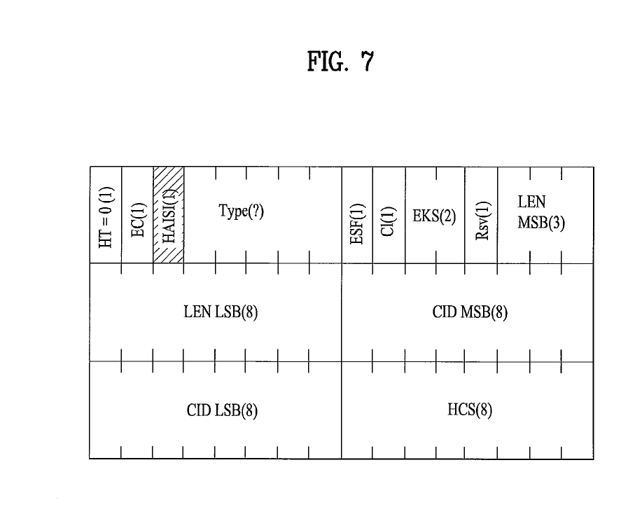

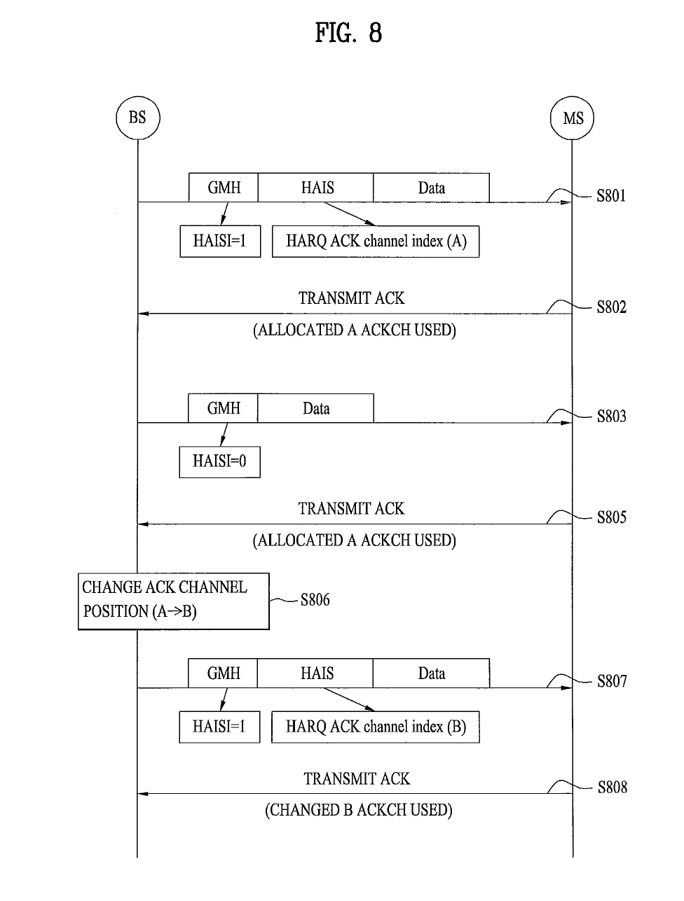

FIG. 7 illustrates another exemplary MAC header that can be used in embodiments of the present invention.

The fields of the MAC header illustrated in FIG. 7 are basically the same as those illustrated in FIG. 6, except that the position of the HAISI field may be different. Instead of the reserved bit after the EKS field, a reserved bit in the Type field of the GMH may be used as the HAISI in FIG. 7.

FIG. 8 illustrates an exemplary method for allocating an ACK channel according to an embodiment of the present invention.

To transmit data, a BS may configure a MAC PDU using a MAC header, one or more subheaders, and data and transmit the MAC PDU to an MS. The BS may need to allocate a new HARQ ACK channel index to the MS at an initial data transmission or reallocate an HARQ ACK channel index to the MS when the allocated ACK channel is changed later. That is, the BS may allocate an HARQ ACK channel to the MS using the MAC header.

To allocate an HARQ ACK channel to the MS, the BS may set the HAISI bit of the GMH (or the HAISI of the Type field of the subheader) and transmit an HARQ ACK channel index Subheader (HAIS) including an HARQ ACK channel index (A) to the MS (S801).

In step 5801, the HAISI may not be allocated to the GMH. In this case, the BS may indicate whether an HARQ ACK channel index is included in a subheader body, using the H_AI parameter in the Type field of a specific subheader. If H_AI is ‘1’, this implies that a HAISI has been allocated. If H_AI is ‘0’, this implies that an HAISI has not been allocated.

Table 1 illustrates an exemplary format of a HAIS including an HARQ ACK channel index.

TABLE 1

| | Size | |
|---|---|---|
| Syntex | (bit) | Note |
| HARQ ACKCH index subheader{ | — | |
| HARQ ACK channel Index | TBD | Indicates the HARQ ACK |
| | | channel index within the |
| | | HARQ ACK/NACK region. |
| | | Default size is 8 bits. |
| } | — | |

Referring to Table 1, HARQ ACK channel Index indicates a channel region to which an HARQ ACK channel has been allocated in an HARQ ACK/NACK region.

Referring to FIG. 8 again, upon receipt of the MAC PDU from the BS, the MS may check the MAC header. If the HAISI is set to ‘1’ or the H_AI is set to ‘1’ in the GMH, the MS checks a related subheader (or an ESH) indicated by the HAISI. Therefore, the MS may transmit an ACK signal to the BS on an ACK channel, ACK channel (A) indicated by HARQ ACK channel index (A) included in the subheader (S802).

If the BS intends to continue to use an already allocated ACK channel or there is no need for changing the allocated ACK channel, the BS may set the HAISI to ‘0’ and transmit it to the MS (S803).

In another embodiment of the present invention, the BS may configure a MAC PDU without an HARQ ACKCH index in a GMH and transmit the MAC PDU to the MS (5803). When determining that the MAC header of the MAC PDU does not include an HARQ ACKCH index or the HAISI is ‘0’ (that is, ACK channel allocation information is not included), the MS may transmit an ACK signal to the BS using the previously allocated ACK channel, ACK channel (A) (S805).

A communication environment or a user requirement may be changed. That is, the position of the already allocated ACK channel may be changed from A to B (S806).

The BS may configure a MAC PDU using a GMH, a HAIS and data and transmit the MAC PDU to the MS. The BS may change the position of the ACK channel using the changed ACK channel position information. The HAISI may be set to 1 in the GMH and a changed HARQ ACK channel index, HAISI(B) may be included in a HAIS to which the HARQ ACK channel is allocated (S807).

Upon receipt of the MAC PDU in step S807, the MS may transmit an ACK signal to the BS on the changed ACK channel, ACK channel (B) (S808).

The MS and the BS retain the HARQ ACK channel index for a predetermined time to which the ACK index retain timer is set in the same manner as described with reference to FIG. 4.

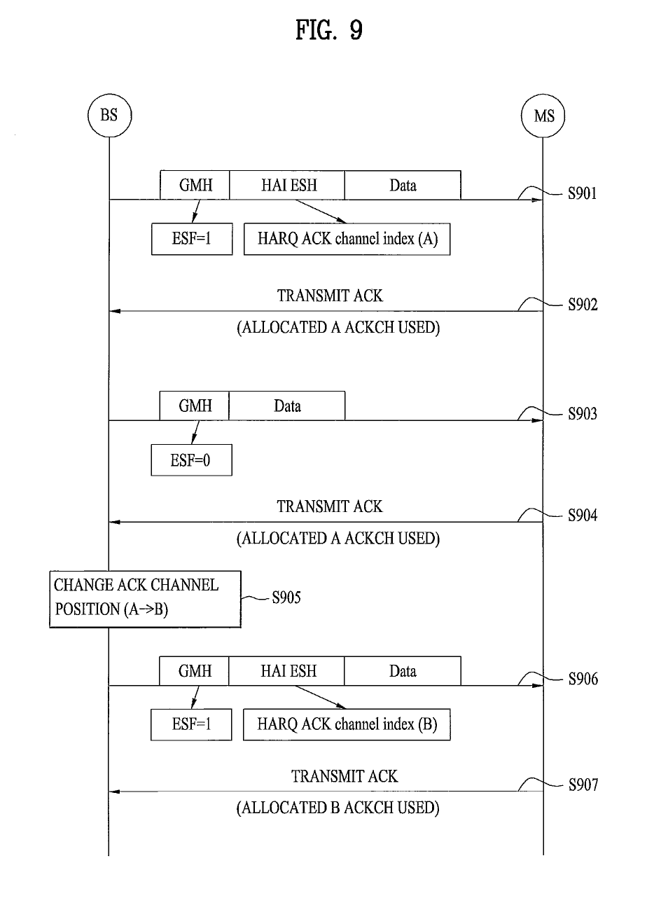

FIG. 9 illustrates another exemplary method for allocating an ACK channel according to the embodiment of the present invention.

To transmit data, a BS may configure a MAC PDU using a MAC header, one or more ESHs, and data and transmit the MAC PDU to an MS. The BS may need to allocate a new HARQ ACK channel index to the MS at an initial data transmission or reallocate an HARQ ACK channel index to the MS when the allocated ACK channel is changed later. That is, the BS may allocate an HARQ ACK channel to the MS using the MAC header.

To allocate an HARQ ACK channel to the MS, the BS may set the ESF of the GMH to 1 and transmit an HARQ ACK channel Index ESH (HAI ESH) including an HARQ ACK channel index (A) to the MS (S901).

In step S901, if the ESF is set to 1 in the GMH, this means that an ESH follows the GMH. Also, HARQ ACK channel index (A) may follow the HAI ESH.

Table 2 illustrates exemplary ESH types used in embodiments of the present invention.

TABLE 2

| Extended | | Extended subheader |
|---|---|---|
| subheader type | Name | body size (bytes) |
| 0 | SDN_SN extended subheader | 1 |
| 1 | DL sleep control extended | 3 |
| | subheader | |
| 2 | Feedback request extended | 3 |
| | subheader | |
| 3 | SN request extended | 1 |
| | subheader | |
| 4 | PDU SN(short) extended | 1 |
| | subheader | |
| 5 | PDU SN(long) extended | 2 |
| | subheader | |
| 6 | HARQ ACK channel index | 1 |
| 7~127 | Reserved | — |

Referring to Table 2, if the Extended subheader type is ‘0’, this indicates SDU_SN extended subheader. If the Extended subheader type is ‘1’, this indicates DL sleep control extended subheader. If the Extended subheader type is ‘2’, this indicates Feedback request extended subheader. If the Extended subheader type is ‘3’, this indicates SN request extended subheader. If the Extended subheader type is ‘4’, this indicates PUD SN(short) extended subheader. If the Extended subheader type is ‘5’, this indicates PUD SN(long) extended subheader. If the Extended subheader type is ‘6’, this indicates an HARQ ACK channel index for allocating an HARQ ACK channel. The other type values are reserved.

Table 3 illustrates an exemplary format of the HAI ESH used in embodiments of the present invention.

TABLE 3

| Name | Size(bit) | Description |
|---|---|---|
| HARQ ACK Channel | 8 | Indicates the HARQ ACK channel index |
| index | | within the HARQ ACK/NACK region. |
| | | Default size is 8 bits. |

Referring to Table 3, HARQ ACK Channel index is 8 bits long, indicating an HARQ ACK channel region.

Referring to FIG. 9 again, upon receipt of the MAC PDU from the BS, the MS checks the MAC header. Since the ESF is set to ‘1’ in the GMH in step S901, the MS checks an ESH. If the type of the ESH indicates an HARQ ACK channel index, the MS may detect ACK channel index (A) included in the ESH. Therefore, the MS may transmit an ACK signal to the BS on the ACK channel, ACK channel (A) (S902).

The BS may continue to use the already allocated ACK channel, ACK channel W. In the absence of any other different type of ESH, the BS may set the ESF to ‘0’ and transmit it to the MS. That is, the HAI ESH for an HARQ ACK channel index may not be used in a MAC PDU (S903).

When determining that the MAC header of the MAC PDU does not include a HAI ESH, the MS may transmit an ACK signal to the BS using the previously allocated ACK channel, ACK channel (A) (S904).

As a communication environment or a user requirement is changed, the position of the already allocated ACK channel may be changed from A to B (S905).

The BS may change the position of the ACK channel using the changed ACK channel position information. The BS may configure a MAC PDU using a GMH, a HAI ESH including the changed ACK channel position information, and data and transmit the MAC PDU to the MS. The ESF of the GMH may be set to 1, indicating inclusion of an ESH and the changed HARQ ACK channel index, HARQ ACKCH Index(B) may be included in the ESH (S906).

Upon receipt of the MAC PDU in step S906, the MS may transmit an ACK signal to the BS on the changed HARQ ACK channel, ACK channel (B) (S907).

The MS and the BS retain the HARQ ACK channel index for a predetermined time to which the ACK index retain timer is set in the same manner as described with reference to FIG. 4.

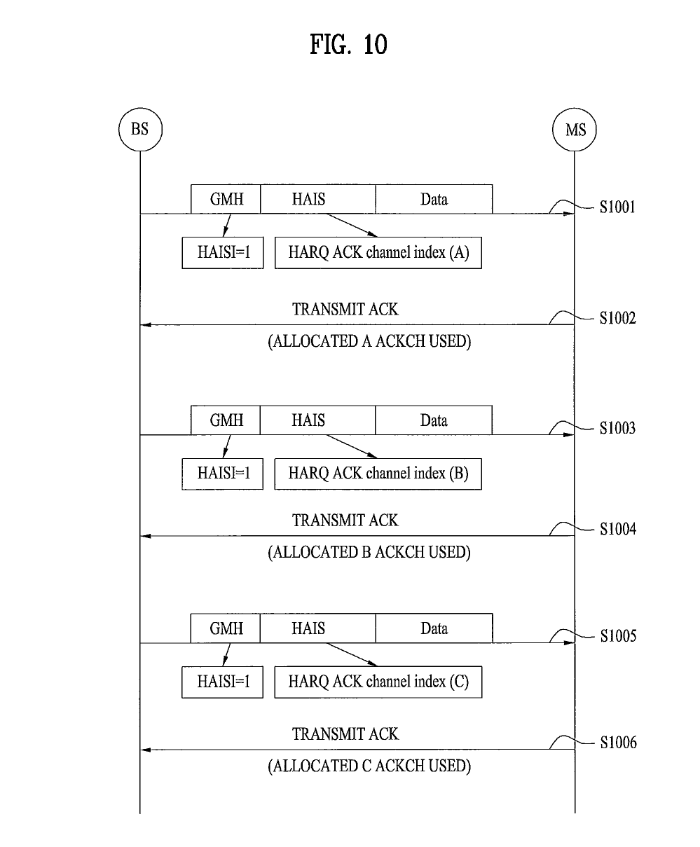

FIG. 10 illustrates another exemplary method for allocating an ACK channel according to the embodiment of the present invention.

When the BS transmits a packet for an HARQ-activated connection, it may transmit an HARQ ACK channel index in each MAC PDU in order to reduce system overhead. In this case, the MS and the BS do not need to store the HARQ ACK channel index separately. The MS and the BS do not need to use a timer for an HARQ ACK channel index (e.g. an ACK channel retain timer). The BS may dynamically allocate an ACK channel position to the MS, that is, the BS may allocate a different ACK channel position to the MS at each time.

Referring to FIG. 10, to transmit a data packet for an HARQ-activated connection, the BS may configure a MAC PDU using a GMH, a HAIS including an HARQ ACK channel index, and data payload and transmit the MAC PDU to the MS (S1001).

In step S1001, a HAISI field may be set to ‘1’ in the GMH. Thus, HARQ ACK channel index (A) may be transmitted in the HAIS of the MAC PDU to the MS.

Upon receipt of the MAC PDU from the BS, the MS may decode the HAIS included in the MAC PDU and transmit an ACK signal to the BS on an ACK channel, ACK channel (A) indicated by HARQ ACK channel index (A) (S1002).

If the BS needs to change the already allocated ACK channel region according to a communication environment, it may transmit a MAC PDU including a new HARQ ACK channel index to the MS. The MAC PDU may contain a GMH, a HAIS and data. In the GMH, the HAISI may be set to ‘1’ to indicate the presence of a HAIS and the HAIS may include an HARQ ACK channel index indicating a new HARQ ACK channel region (B) (S1003).

If the MS receives the MAC PDU and successfully decodes the HAIS in step S1003, the MS may transmit an ACK signal to the BS on the changed HARQ ACK channel, ACK channel (B) (S1004).

When the BS needs to allocate a new ACK channel region (C) to the MS, the BS may allocate the new ACK channel region (C) to the MS in the same manner as in step S1001 or S1003 (S1005).

Thus the MS may transmit an ACK signal in the ACK channel region (C) (S1006).

A description will be given of a method for allocating an ACK channel using an extended header according to a further embodiment of the present invention.

In accordance with embodiments of the present invention, a subheader may be referred to as an extended header. A method for transmitting and receiving ACK channel region information using an extended header may be applied to a case where a MAC management message or a MAC control message is transmitted.

For example, the BS may transmit MAC management messages to the MS without solicitation from the MS. In this context, the BS may notify the MS of an ACK channel region by transmitting a MAC management message including an extended header with ACK channel region information. The MS may notify the BS whether it has successfully received the MAC management message using the received ACK channel region information.

Unsolicited MAC management messages may include a Sleep Response (SLP-RSP) message, a Subscriber Basic Capability Response (SBC-RSP) message, a Registration Response (REG-RSP) message, etc. in embodiments of the present invention.

Indicating an ACK channel in an extended header obviates the need for allocating radio resources in which an MS will transmit an ACK message or a Bandwidth Request (BR) header in response to an unsolicited MAC message.

Methods for allocating an ACK channel to a specific MS implicitly and explicitly by a BS according to embodiments of the present invention will be described below.

The BS may notify the MS of an HARQ ACK/NACK channel in a general implicit manner. The BS allocates as many ACK channels as Logical Resource Units (LRUs) to the MS and maps each LRU to an ACK channel.

For example, in the case where the BS allocates three LRUs to an MS, the BS may map the LRUs to three ACK channels respectively and allocate the LRUs to the MS. The MS may transmit an ACK/NACK only on a first ACK channel. When LRUs are mapped to ACK channels for implicit signaling, the BS does not need to indicate an ACK channel position separately to the MS.

In an explicit method, the BS may allocate an ACK channel to the MS by transmitting an extended header including ACK channel region information (e.g. an ACKCH indicator or an ACKCH/ACK message resource region) in a MAC management message.

As described above, the MS may transmit ACK information (e.g. an HARQ/CQICH ACK channel or ACK message) to the BS in the implicitly allocated ACK channel region or in the ACK channel region allocated by the extended header of the MAC management message. As the MS transmits two ACK (or NACK) messages in response to the MAC management message, transmission errors that might be generated during transmission of a single ACK/NACK message may be prevented.

That is, the BS may determine using second ACK information whether the MAC management message has reliably transmitted, irrespective of an ACK to NACK error or a NACK to ACK error in a first HARQ ACK/NACK channel. An ACK channel indicator included in the subheader of the MAC management message may contain resource allocation information for transmission of ACK information (an ACK channel or an ACK message).

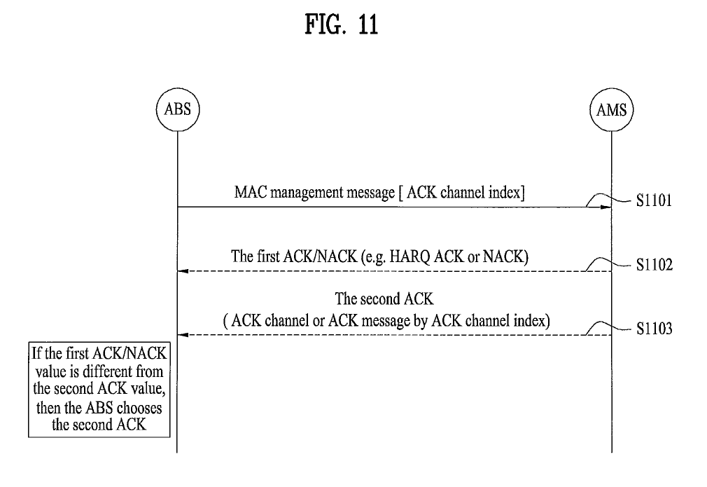

FIG. 11 illustrates a further exemplary method for allocating an ACK channel according to the embodiment of the present invention.

In the embodiments of the present invention, the term ‘BS’ is used interchangeably with Advanced BS (ABS) and the term ‘MS’ is used interchangeably with Advanced MS (AMS). It is assumed in FIG. 11 that an ABS may allocate one or more ACK channel regions, preferably two ACK channel regions to an AMS explicitly or implicitly.

The ABS may implicitly allocate a predetermined number of HARQ ACK/NACK channels for a predetermined number of LRUs. In addition, the ABS may explicitly transmit a MAC management message including an ACK channel index (or an ACK channel indicator) to the AMS. The ACK channel index may be included in an extended header (or subheader) of the MAC management message (S1101).

The AMS may transmit ACK/NACK information (e.g. a first ACK/NACK message or ACK/NACK channel) for the MAC management message to the ABS in an implicitly allocated HARQ ACK/NACK channel region (e.g. a first ACK channel region) (S1102).

In addition, upon receipt of the ACK channel index in the subheader of the MAC management message, the AMS may transmit ACK/NACK information (e.g. a second ACK message) to the ABS in an ACK channel region indicated by the ACK channel index (e.g. a second ACK channel region) (S1103).

Preferably, the ACK channel region (i.e. the second ACK/NACK channel region) carrying the ACK information in step S1103 uses different radio resources from the ACK/NACK channel region (i.e. the first ACK/NACK channel region) carrying the ACK information in step S1103. If the first ACK/NACK information is different from the second ACK/NACK information, the ABS may determine that the second ACK information is reliable.

For instance, if the first ACK/NACK information is a NACK and the second ACK information is an ACK, the ABS may determine that the packet has successfully been transmitted to the AMS, considering that the ACK information received in the first ACK channel region is wrong. Hence, the ABS deletes the packet from a transmission buffer.

If the first ACK/NACK information is a NACK and the second ACK information is not received, the ABS may determine that the packet has a transmission error. Hence, the ABS retransmits the packet to the AMS.

If the first ACK/NACK information is an ACK and the second ACK information is not received, the ABS retransmits the packet to the AMS, considering based on the second ACK information value that the packet has a transmission error.

If the first ACK/NACK information is an ACK and the second ACK information is received, the ABS deletes the packet from the transmission buffer, considering that the packet has successfully been transmitted to the AMS.

Owing to the double transmission of ACK/NACK information for a MAC management message from the AMS, the ABS may transmit a MAC management message more reliably to the AMS.

In the case where the ACK/NACK messages carry different information in steps S1102 and S1103 of FIG. 11, the ABS may operate differently from the manner described above.

For example, if the first ACK/NACK information is an ACK and the second ACK/NACK information is a NACK or if the first ACK/NACK information is a NACK and the second ACK/NACK information is an ACK, the ABS may determine that the MAC management message has been failed. Accordingly, the ABS may retransmit the MAC management message to the AMS. Needless to say, if the first and second ACK/NACK information carries the same ACK or NACK, the ABS operates according to the ACK or NACK.

A method for checking errors in a MAC management message transmitted in the method of FIG. 11 using a subheader may be applied to persistent allocation being a VoIP scheduling scheme or group resource allocation.

For example, the ABS may persistently allocate a specific region to the AMS, for persistent resource allocation. However, the ABS may de-allocate the persistently allocated resource region from the AMS according to a communication situation. For resource de-allocation, the ABS may transmit control information to the AMS.

To determine whether the AMS has successfully received the control information, the ABS may allocate an ACK channel region to the AMS using an extended header. The AMS may transmit ACK information or an ACK message in the allocated ACK channel region to the ABS.

Now a description will be given of an MS and a BS that implement the embodiments of the present invention described before with reference to FIGS. 2 to 11 according to an embodiment of the present invention.

The MS may operate as a transmitter on an uplink and as a receiver on a downlink. The BS may operate as a receiver on the uplink and as a transmitter on the downlink. Therefore, the MS and the BS may each include a transmitter and a receiver to transmit and receive information or data.

The transmitter and the receiver may each include a processor, a module, a part and/or means to implement the embodiments of the present invention. Especially the transmitter and the receiver may each include a module (means) for encrypting a message, a module for decrypting an encrypted message, and an antenna for transmitting and receiving messages.

The MS used in the embodiments of the present invention may include a low-power Radio Frequency/Intermediate Frequency (RF/IF) module. In addition, the MS may include means, modules or parts for performing a control function, a MAC frame conversion control function based on service characteristics and a propagation environment, a handover function, an authentication and encryption function, a packet modulation and demodulation function for data transmission and reception, a high-speed packet channel coding function, and a real-time modem control function in order to implement the above-described embodiments of the present invention.

The BS may transmit data received from a higher layer to the MS in a wireless or wired fashion. The BS may include a low-power RF/IF module. In addition, the BS may include means, modules or parts for performing a control function, OFDMA packet scheduling, Time Division Duplex (TDD) packet scheduling and channel multiplexing, a MAC frame conversion control function based on service characteristics and a propagation environment, a high-speed traffic real-time control function, a handover function, an authentication and encryption function, a packet modulation and demodulation function for data transmission and reception, a high-speed packet channel coding function, and a real-time modem control function in order to implement the above-described embodiments of the present invention.

As is apparent from the above description, the embodiments of the present invention have the following effects.

Firstly, an MS and a BS can efficiently transmit and receive data.

Secondly, the MS can be allocated an uplink ACK channel more efficiently than in a general uplink ACK channel allocation.

Thirdly, an ACK channel can be efficiently allocated to the MS in various methods using a MAC header.

Fourthly, since an HARQ ACK channel index is included in a MAC header, downlink overhead is reduced, compared to explicit transmission of an HARQ ACK index on a control channel. In addition, unnecessary uplink resource consumption that might be caused when an HARQ ACK channel is allocated in units of CCEs or RBs can be reduced. When previous HARQ ACK channel position information is still used, the MAC header does not include an HARQ ACK channel index, thereby conserving resources, relative to notification of an ACK channel on a control channel at each time.

The embodiments of the present invention are applicable to various wireless access systems including a 3GPP system, a 3GPP2 system, and/or an IEEE 802.xx system. Besides these wireless access systems, the exemplary embodiments of the present invention are applicable to all technical fields to which wireless access systems are applied.

Those skilled in the art will appreciate that the present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein. It will be obvious to those skilled in the art that claims that are not explicitly cited in each other in the appended claims may be presented in combination as an exemplary embodiment of the present invention or included as a new claim by a subsequent amendment after the application is filed.

1. A method for allocating an ACKnowledgement (ACK) channel, comprising:
receiving first data including ACK channel position information;
transmitting an ACK signal on an ACK channel indicated by the ACK channel position information; and
starting an ACK channel timer.

2. The method according to claim 1, wherein when the ACK channel is initially allocated or already set ACK channel position information is changed, the ACK channel position information is included in the first data.

3. The method according to claim 1, wherein the ACK channel position information is included in a header of the first data.

4. The method according to claim 3, wherein the header is one of a Generic Medium Access Control (MAC) Header (GMH), a subheader, and an extended subheader.

5. The method according to claim 3, wherein the header is a GMH and the GMH includes a first indicator indicating whether the ACK channel position information is included.

6. The method according to claim 5, wherein the first indicator is allocated to a reserved bit of the GMH or a type field of the MAC header.

7. The method according to claim 5, wherein the first data further includes a subheader and the first indicator indicates whether the ACK channel position information is included in the subheader.

8. The method according to claim 3, wherein the header is a subheader including a type field and a body field and the type field indicates whether the body field includes the ACK channel position information.

9. The method according to claim 5, wherein the first data further includes an extended subheader and the first indicator indicates whether the ACK channel position information is included in the extended subheader.

10. The method according to claim 1, further comprising receiving second data that does not include the ACK channel position information, wherein when the ACK channel position information is needed, the ACK channel position information is selectively included in the first data.

11. The method according to claim 1, further comprising deleting the ACK channel position information, upon expiration of the ACK channel timer.

12. A method for allocating an ACKnowledgement (ACK) channel, comprising:
transmitting first data including ACK channel position information;
receiving an ACK signal on an ACK channel indicated by the ACK channel position information; and
starting an ACK channel timer, upon receipt of the ACK signal.

13. The method according to claim 12, wherein when the ACK channel is initially allocated or already set ACK channel position information is changed, the ACK channel position information is selectively included in the first data.

14. The method according to claim 12, further comprising transmitting a second message that does not include the ACK channel position information.

15. The method according to claim 12, wherein the ACK channel position information is included in a header of the first data and the header is one of a Generic Medium Access Control (MAC) Header (GMH), a subheader, and an extended subheader.

16. The method according to claim 15, wherein the GMH includes a first indicator indicating whether the ACK channel position information is allocated.

17. The method according to claim 16, wherein the first data includes the GMH and the subheader and the first indicator indicates whether the ACK channel position information is allocated in the subheader.

18. The method according to claim 15, wherein the subheader includes a type field and a body field and the type field indicates whether the body field includes the ACK channel position information.

19. The method according to claim 15, wherein the first data includes the GMH and the extended subheader, and the GMH includes an indicator indicating whether the ACK channel position information is allocated in the extended subheader.

20. The method according to claim 12, further comprising deleting the ACK channel position information, upon expiration of the ACK channel timer.
